(19) United States
(12) Patent Application Publication
(10) Pub. No.: US 2008/0239130 A1
(43) Pub. Date: Oct. 2, 2008

(54) DRIVE METHOD OF CCD-TYPE SOLID-STATE IMAGE PICKUP DEVICE AND IMAGE PICKUP APPARATUS

(76) Inventor: Yoshinori FURUTA, Kurokawa-gun (JP)

Correspondence Address: BIRCH STEWART KOLASCH & BIRCH, PO BOX 747, FALLS CHURCH, VA, 22040-0747, US

(21) Appl. No.: 12/058,257

(22) Filed: Mar. 28, 2008

(30) Foreign Application Priority Data
Mar. 30, 2007 (JP) P2007-094676

(51) Int. Cl. H04N 5/335

(52) U.S. Cl. 348/311; 348/E05.091

(57) ABSTRACT

A drive method of a CCD-type solid-state image pickup device, the image pickup device comprising vertical charge transfer path with vertical transfer electrodes, wherein the method transfers signal charges read from pixels of the image pickup device along the vertical charge transfer path, the method comprising a plurality of steps each of where transferring the signal charges along the vertical charge transfer path is stopped and the signal charges are retained in potential well(s) formed under given one(s) of the vertical transfer electrodes during the stopping of the transferring, wherein said plurality of steps comprises a given step in which the given one(s) of the vertical transfer electrodes are changed from those of the vertical transfer electrodes in another one of said plurality of steps.

### BACKGROUND OF THE INVENTION

1. Field of the Invention

This invention relates to a drive method of a CCD-type solid-state image pickup device and an image pickup apparatus and in particular to a drive method of a CCD-type solid-state image pickup device and an image pickup apparatus capable of well suppressing vertical line noise caused by a dark current.

2. Description of the Related Art

In a CCD-type solid-state image pickup device for transferring a signal charge detected by a photodiode (pixel) to an output stage by means of a vertical charge transfer path (VCCD) and a horizontal charge transfer path (HCCD) r a dark current mixes into a signal charge retaining potential well of the vertical charge transfer path stopped during transfer in the horizontal charge transfer path.

The occurrence ratio of the dark current varies for each vertical transfer electrode forming the signal charge retaining potential well and if a vertical transfer electrode for producing a large amount of dark current exists, the charge amount passing through the vertical transfer electrode increases and this appears as vertical line noise in an picked-up image, which becomes one factor of degrading the image quality of the picked-up image.

Particularly, if a dark scene is photographed in a high speed mode, the signal charge amount responsive to the incidence light amount lessens and thus the dark current component relatively grows and a vertical line is conspicuous. Then, the applicant previously proposes an art of decreasing the capacity of a potential well used for vertical transfer at the high speed mode photographing time more than the capacity of a potential well used for vertical transfer at the low speed mode photographing time (decreases the capacity by decreasing the number of vertical transfer electrodes to form one potential well) and suppressing the effect of the dark current as described in JP-A-2005-286470.

According to the related art described above, vertical line noise caused by the dark current can be suppressed. However, since making pixels smaller has advanced for the CCD-type solid-state image pickup device of recent years, the signal charge amount that can be detected by one pixel further lessens and moreover the user's demand for photographing in the high speed mode also increases.

Thus, development of another art for removing vertical line noise caused by dark current particularly at the photographing time in the high speed mode is required.

### SUMMARY OF THE INVENTION

It is an object of the invention to provide a drive method of a CCD-type solid-state image pickup device and an image pickup apparatus capable of suppressing vertical line noise caused by a dark current.

A driver method of a CCD-type solid-state image pickup device, the image pickup device comprising vertical charge transfer path with vertical transfer electrodes, wherein the method transfers signal charges read from pixels of the image pickup device along the vertical charge transfer path, the method comprising a plurality of steps each of where transferring the signal charges along the vertical charge transfer path is stopped and the signal charges are retained in potential well(s) formed under given one(s) of the vertical transfer electrodes during the stopping of the transferring, wherein said plurality of steps comprises a given step in which the given one(s) of the vertical transfer electrodes are changed from those of the vertical transfer electrodes in another one of said plurality of steps.

According to an aspect of the invention, there is provided the drive method of the CCD-type solid-state image pickup device, wherein, in every steps of said plurality or steps, the given one(s) of the vertical transfer electrodes are changed from those in the previous step of the given step.

According to an aspect of the invention, there is provided the drive method of the CCD-type solid-state image pickup device, wherein said plurality of steps conduct reading the signal charges of the pixels in a plurality of fields, the given one(s) of the vertical transfer electrodes on reading those of the signal charges in one of the fields are changed from those of the vertical transfer electrodes on reading those of the signal charges in another one of the fields.

According to an aspect of the invention, there is provided the drive method of the CCD-type solid-state image pickup device, wherein said plurality of steps are conducted for reading those of the signal charges in the same field, and in every steps of said plurality of steps, the given one(s) of the vertical transfer electrodes are changed from those in the previous step of the given step.

According to an aspect of the invention, there is provided the drive method of the CCD-type solid-state image pickup device, wherein the given one(s) of the vertical transfer electrodes are plural electrodes, and a part of the plural electrodes is changed in the given step.

According to an aspect of the invention, there is provided the drive method of the CCD-type solid-state image pickup device, wherein the given one(s) of the vertical transfer electrodes are changed cyclically over said plurality of steps.

According to an aspect of the invention, there is provided the drive method of the CCD-type solid-state image pickup device, wherein the image pickup device further comprises color filters for the respective pixels so as to pick up a color image, and the given one(s) of the vertical transfer electrodes are transfer electrodes, provided along the vertical charge transfer path, that form potential wells for retaining those of the signal charges of the same color.

According to an aspect of the invention, there is provided the drive method of the CCD-type solid-state image pickup device, wherein the given one(s) of the vertical transfer electrodes are vertical transfer electrode(s) other than a vertical transfer electrode that also acts as a read electrode.

An image pickup apparatus of the invention includes a CCD-type solid-state image pickup device and a CCD drive section that executes any drive method as described above.

### BRIEF DESCRIPTION OF THE DRAWINGS

FIGS. 1A and 11B are surface schematic drawings of CCD-type solid-state image pickup devices incorporating one embodiment of the invention;

FIG. 2A is a drawing to show how to change capacity of potential well in a low speed mode;

FIG. 2B is a drawing to show how to change capacity of potential well in a high speed mode;

FIG. 3 is a usual drive time chart of a vertical charge transfer path;

FIG. 4 is a state transition diagram for each stop when the vertical charge transfer path is driven in accordance with the usual drive time chart;

FIG. 5 is a drawing to describe positions where dark current mixes into signal charge;

FIG. 6 is a drive time cheat of a vertical charge transfer path to show a drive method according to a first embodiment of the invention;

FIG. 7 is a state transition diagram for each stop when the vertical charge transfer path is driven in accordance with the time chart of FIG. 6;

FIG. 8 is a drawing to show a drive method according to a modified example of the first embodiment of the invention;

FIG. 9 is a state transition diagram for each stop of the vertical charge transfer path according to a drive method according to another modified example of the first embodiment of the intention;

FIG. 10A is drive time charts to show a drive method according to a second embodiment of the invention to show a first field when a CCD-type solid-state image pickup device is driven in two fields;

FIG. 10B is drive time charts to show a drive method according to a second embodiment of the invention to show a second field when a CCD-type solid-state image pickup device is driven in two fields;

FIG. 11 is a state transition diagram for each stop when a vertical charge transfer path is driven in accordance with the time chart of FIG. 10A;

FIG. 12 is a state transition diagram for each stop when the vertical charge transfer path is driven in accordance with the time chart of FIG. 10B;

FIG. 13 is a state transition diagram for each stop in a first field to show a modified example of the second embodiment of the invention;

FIG. 14 is a state transition diagram for each stop in a second field to show the modified example of the second embodiment of the invention;

FIG. 15 is a surface schematic drawing of a CCD-type solid-state image pickup device with color filters arranged as beyer;

FIG. 16 is a state transition diagram for each stop when usual drive of the CCD-type solid-state image pickup device in FIG. 15 is performed;

FIG. 17 is a drawing to describe positions where dark current mixes into signal charge in the CCD-type solid-state image pickup device in FIG. 15;

FIG. 18 is a state transition diagram for each stop when the CCD-type solid-state image pickup device in FIG. 15 is driven according to the drive method of the first embodiment of the invention;

FIG. 19 is a state transition diagram for each stop of a vertical charge transfer path when driven according to a drive method according to a third embodiment of the invention;

FIG. 20 is a surface schematic drawing of a CCD-type solid-state image pickup device for picking up a color image, of honeycomb pixel arrangement;

FIG. 21 is an enlarged view of a part of FIG. 20; and

FIG. 22 is an enlarged view of one pixel in FIG. 21.

### DETAILED DESCRIPTION OF THE INVENTION

Referring now to the accompanying drawings, there are shown embodiments of the invention.

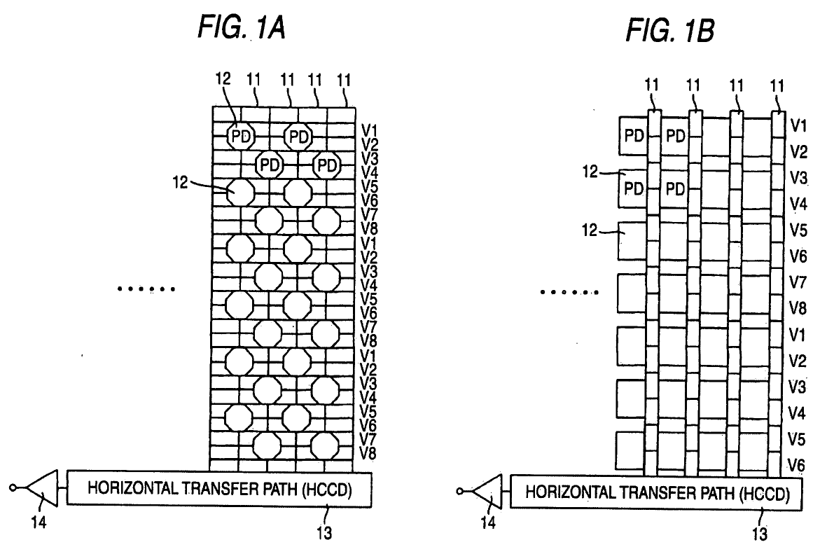

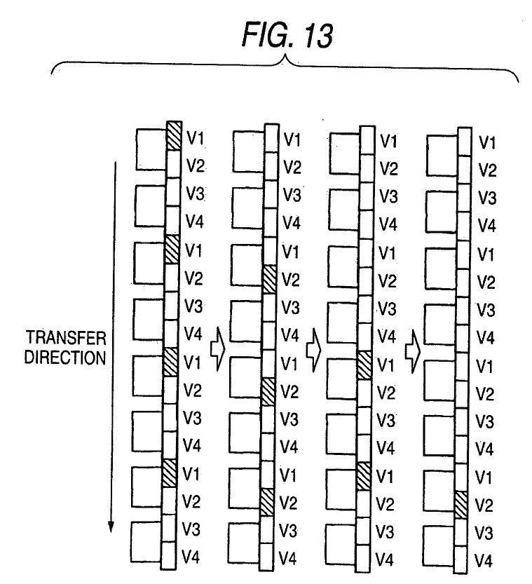

FIGS. 1A and 13 are surface schematic drawings of CCD-type solid-state image pickup devices incorporating one embodiment of the invention. FIG. 1A shows a CCD-type solid-state image pickup device of honeycomb pixel arrangement wherein each odd-numbered pixel (photodiode (PD)) row is shifted a half pitch at a time relative to each even-numbered pixel row. Each Vertical charge transfer path 11 extending in a vertical direction along each pixel column is provided in a meandering manner so as to avoid pixels 12, a horizontal charge transfer path 13 is provided along the end parts of the vertical charge transfer paths 11, and an amplifier 14 for converting the signal charge amount into a voltage value signal is provided at the output stage of the horizontal charge transfer path 13. V1, V2, . . . V8 denote transfer electrodes and the same transfer pulse is applied to the transfer electrodes of the same number.

FIG. 1B shows a CCD-type solid-state image pickup device of tetragonal lattice arrangement of pixels 12. Each vertical charge transfer path 11 extending in a line along each pixel column is provided, a horizontal charge transfer path 13 is provided along the end parts of the vertical charge transfer paths 11, and an amplifier 14 for converting the signal charge amount into a voltage value signal is provided at the output stage of the horizontal charge transfer path 13. V1, V2, . . . V8 denote transfer electrodes like those described above and the same transfer pulse is applied to the transfer electrodes of the same number.

An image pickup apparatus installing the CCD-type solid-state image pickup device shown in FIG. 1A or 1B is provided with CCD drive means such as a timing generator for applying a read pulse and a transfer pulse to the transfer electrodes V1, V2, . . . of the CCD-type solid-state image pickup device, and a CPU for controlling the image pickup apparatus controls the CCD drive means, whereby the CCD-type solid-state image pickup device is driven as follows: In the description that follows, the CCD-type solid-state image pickup device shown in FIG. 1B is taken as an example, but the following embodiment can also be applied to the CCD-type solid-state image pickup device shown in FIG. 1A in a similar manner.

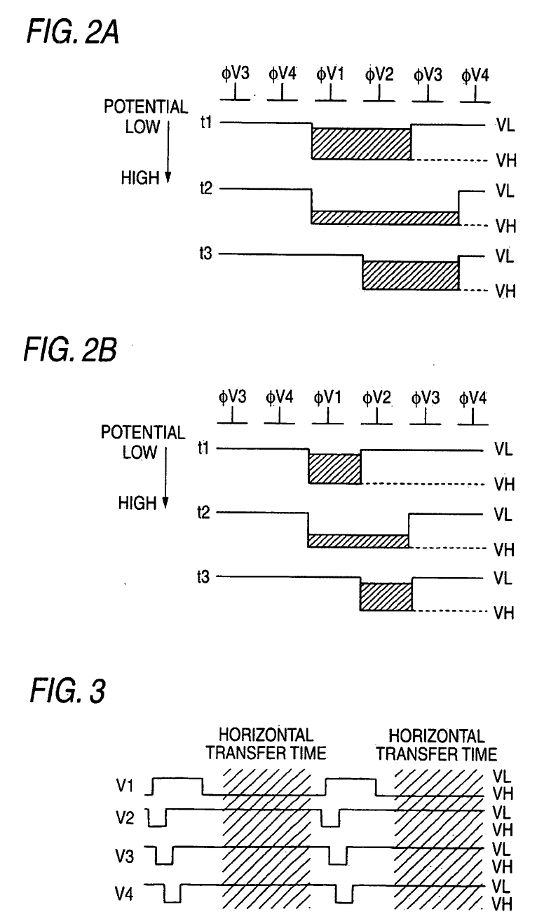

FIG. 2A is a drawing to show how to execute vertical transfer of signal charges obtained by photographing in a low speed mode as in the art in JP-A-2005-286470. In the photographing in the low speed mode, the obtained signal charge amount is large and thus the capacity of a potential well used for the vertical transfer is taken large and the signal charges are transferred by changing two transfer electrodes→three transfer electrodes→two transfer electrodes→ . . . .

FIG. 2B is a drawing to show how to execute vertical transfer of signal charges obtained by photographing in a high speed mode. As described in JP-A-2005-286470, in the high speed mode, the signal charge amount is small and thus the capacity of a potential well is decreased and the signal charges are transferred by changing one transfer electrode→two transfer electrodes→one transfer electrode→ . . . . In the embodiment the art of the invention and the art described in JP-A-2005-286470 are used in combination to enhance the quality of a picked-up image particularly in the high speed photographing mode.

FIG. 3 is a time Chart to show the usual drive timing of the CCD-type solid-state image pick-up device; it shows vertical transfer pulses applied to the electrodes V1, V2, V3, and V4. That is, when the vertical transfer pulse changes, the potential well is expanded and contracted as two transfer electrodes→three transfer electrode→two transfer electrodes→ . . . or one transfer electrode→two transfer electrodes→one transfer electrode→ . . . mentioned above in accordance with the vertical transfer pulse and the potential well proceeds in the direction of the horizontal charge transfer path.

The signal charge transferred to the end part of the vertical charge transfer path 11 on the side of the horizontal charge transfer path is moved to the horizontal charge transfer path 13 and then is transferred to the amplifier 14 by means of the horizontal charge transfer path 13. During the transfer period of the horizontal charge transfer path, the signal charge cannot be moved to the horizontal charge transfer path 13 and thus the vertical charge transfer path 11 is stopped. During the stopping, the signal charge on the vertical charge transfer path 11 is retained in the potential well formed in the vertical charge transfer path.

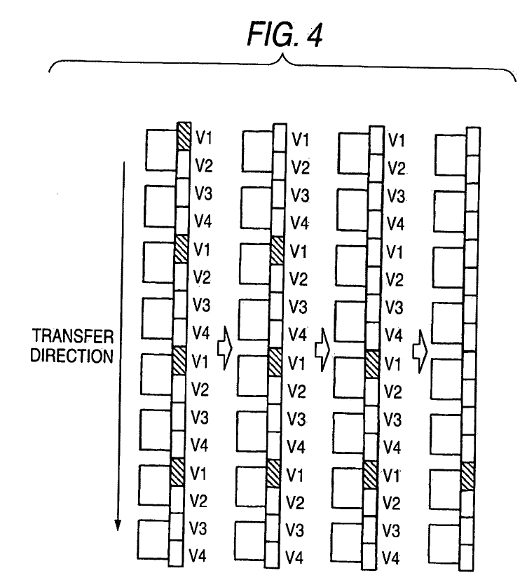

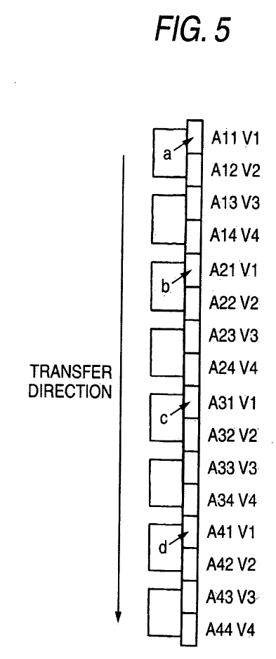

Usually, while the vertical charge transfer path stops, the transfer electrode forming the potential well is fixed. In the time chart of FIG. 3, the electrode V1 is the transfer electrode forming the potential well during the stopping. A problem caused by fixing the transfer electrode forming the potential well during the stopping will be discussed below with reference to FIGS. 4 and 5.

FIG. 4 is a drawing to show the state transition each time the vertical charge transfer path is stopped. Whenever the vertical charge transfer path is stopped, the signal charge is retained in the potential well formed under the transfer electrode V1. If the vertical charge transfer path is driven for transfer, the signal charge is transferred from under V1 to under V2→under V3→under V4→under V1 and when the signal charges comes under V1, the vertical charge transfer path again stops.

It is assumed that a dark current mixed at the position of the first electrode V1 shown in FIG. 5 is A11, that a dark current mixed at the next electrode V2 is A12, that a dark current mixed at the next electrode V3 is A13, that a dark current mixed at the next electrode V4 is A14, that a dark current mixed at the next electrode V1 is A21, that a dark current mixed at the next electrode V2 is A22, . . . .

Since the dark current much mixes while the vertical charge transfer path stops, the Clark current added to signal charge a becomes A11+A21+A31+A41, the dark current added to signal charge b becomes A21+A31+A41, the dark current added to signal charge c becomes A31+A41, and the dark current added to signal charge d becomes A41.

That is, the dark current A31 mixes into the signal charges a, b, and C and the dark current A41 mixes into the signal charges a, b, C, and d. If the dark current A31 or A41 increases due to manufacturing variations of solid-state image pickup devices, the dark current mixes into the signal charges passing through under the transfer electrode generating the dark current A31, A41, causing vertical line noise to occur.

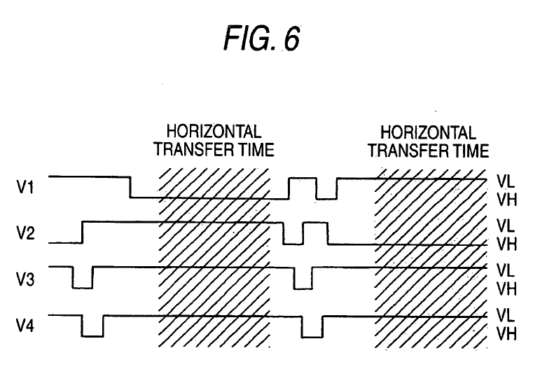

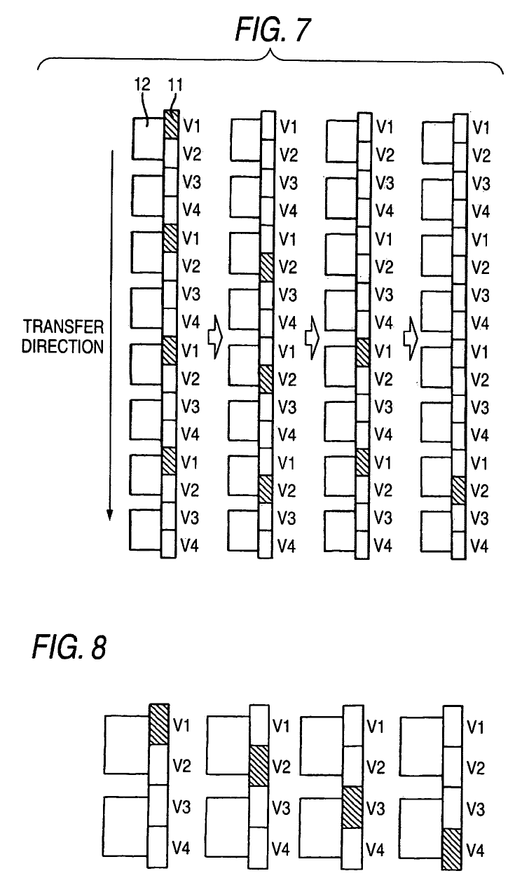

Then, in the first embodiment of the invention the vertical charge transfer path is driven in accordance with a time chart of FIG. 6. That is, whenever the vertical charge transfer path is stopped, the transfer electrode to form the potential well for retaining the signal charge is changed as V1→V2→V1→V2→ . . . alternately. This state transition is shown in FIG. 7.

If control is performed as shown in FIG. 7, the dark current mixed into the signal charge a in FIG. 5 becomes A11+A22+A31+A42, the dark current mixed into the signal charge b becomes A21+A32+A41, the dark current mixed into the signal charge c becomes A31+A42, and the dark current mixed into the signal charge d becomes A41. That is, retaining of signal charge at all times under a specific, transfer electrode where much dark current is generated is eliminated and occurrence of vertical line noise is suppressed.

In the embodiment shown in FIGS. 6 and 7, the transfer electrode to form the potential well for retaining the signal charge is changed as V1→V2→V1→V2→ . . . alternately, but may be changed as V1→V2→→V3→V4→V1→ . . . cyclically as shown in FIG. 8. In the embodiment in FIG. 8, vertical line noise is suppressed more than in the embodiment in FIG. 6.

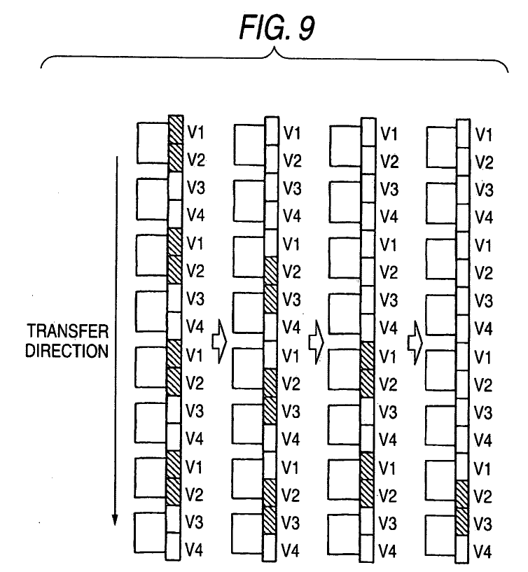

In the embodiment described above, while the vertical charge transfer path stops, the potential well for retaining the signal charge is formed of one transfer electrode, but may be formed of two transfer electrodes. Also in this case, vertical line noise can be suppressed by shifting a part of the transfer electrodes to form the potential well for retaining the signal charge for each stop, for example, as shown in FIG. 9. All may be shifted, of course.

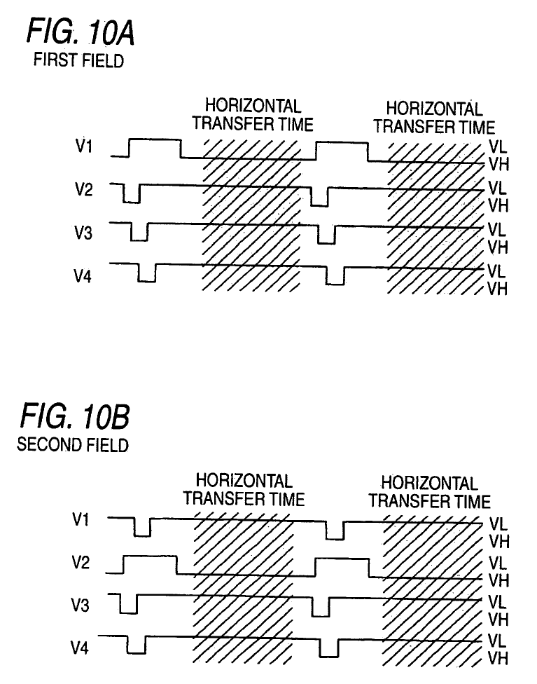

FIGS. 10A and 101B are drive time charts of a vertical charge transfer path according to a second embodiment of the invention, A CCD-type solid-state image pickup device of the embodiment is read in two fields; FIG. 10A is a time chart of the first field and FIG. 10B is a time chart of the second field.

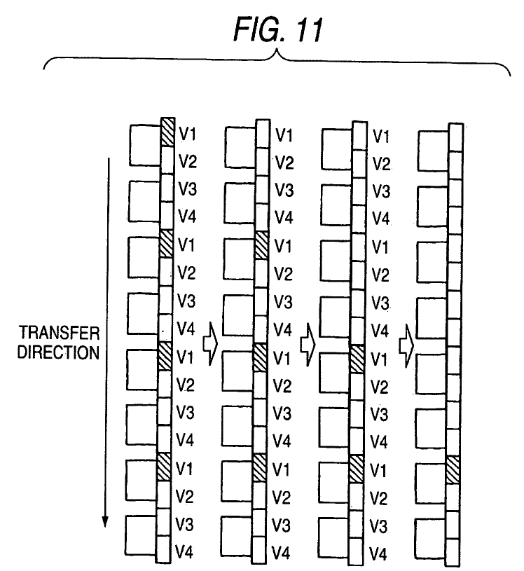

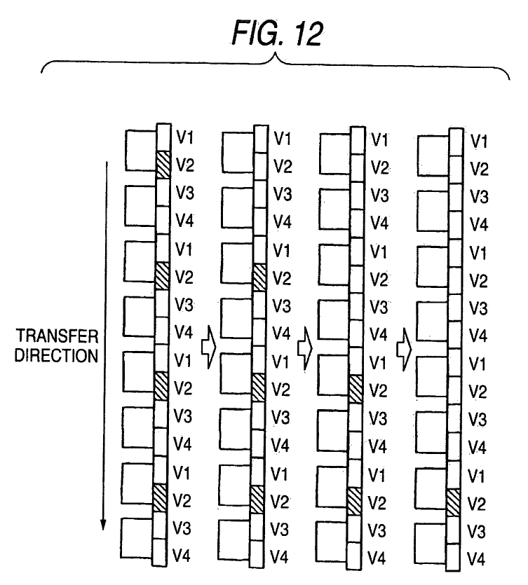

FIGS. 11 and 12 are diagrams to show the state transition of the first field and that of the second field. In the first field, while the vertical charge transfer path stops, signal charge is retained in a potential well formed under a transfer electrode V1. In the second field, while the vertical charge transfer path stops, signal charge is retained in a potential well formed under a transfer electrode V2.

Thus, the electrode is changed for each field, whereby vertical line noise caused by dark current can be made hard to be conspicuous. In the embodiment, the transfer pulse drive pattern becomes a repetition of the same drive pattern in the first field and also becomes a repetition of the same drive pattern in the second field, so that complicated drive becomes unnecessary and it becomes easy to generate the drive pattern.

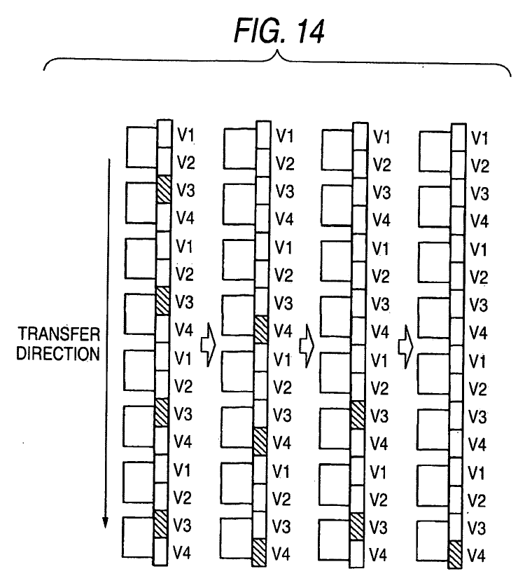

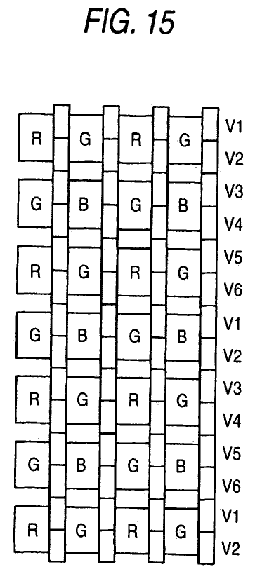

FIGS. 13 and 14 are state transition diagrams to show a modified example of the second embodiment of the invention. In the second embodiment, the potential well for retaining the signal charge is always formed under the transfer electrode V1 in the first field and the potential well for retaining the signal charge is always formed under the transfer electrode V2 in the second field. In the modified example, however, the potential well is changed as V1→V2→V1→V2→ . . . alternately in the first field and the potential well is changed as V3→V4→V3→V4→ . . . alternately in the second field.

That is, in the modified example, the electrode (V1, V2) to form the potential well while transfer of the first field stops and the electrode (V3, V4) to form the potential well while transfer of the second field stops are made different and further the electrodes are changed alternately for each transfer stop of the first, second field.

According to the configuration, the potential well for retaining the signal charge is not fixed and is changed at random, so that vertical line noise further becomes hard to be conspicuous as compared with the second embodiment.

The modified example of the first embodiment shown in FIG. 9 can also be applied to the second embodiment.

FIG. 5 is a surface schematic drawing of a CCD-type solid-state image pickup device incorporating a drive method according to a third embodiment of the invention. Electrodes V1, V2, V3, V4, V5, V6, V1, V2, . . . of six-phase drive are placed as transfer electrodes of the CCD-type solid-state image pickup device.

Pixels (photodiodes) are arranged like a tetragonal lattice on which color filters of the three primary colors (R=red, G=green, B-blue) are arranged as beyer. Seeing the drawing for each column, a column where R and G pixels are placed alternately and a column where B and G pixels are placed alternately are arranged alternately.

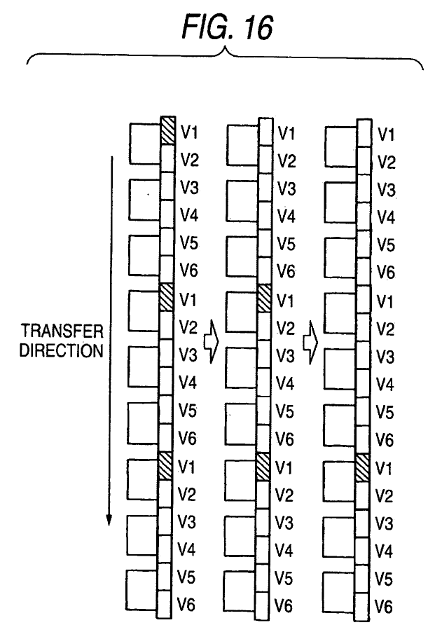

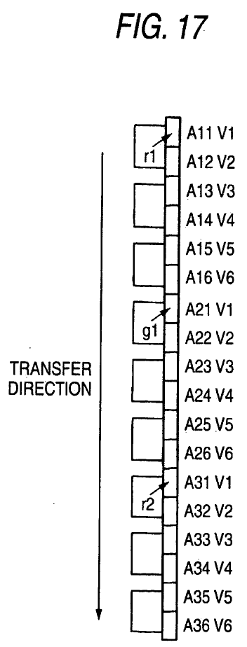

FIG. 16 shows the state transition of usual drive of the CCD-type solid-state image pickup device for picking up a color image. In the usual drive, the potential well for retaining the signal charge during the transfer stop is always formed of the electrode V1. Thus, referring to FIG. 17 similar to FIG. 5, dark current mixed into a red signal charge r1 becomes A11+A21+A31+A41 and dark current mixed into the next red signal charge r2 of the same column becomes A31+A41. Therefore, vertical line noise for each color is conspicuous even with the CCD-type solid-state image pickup device for picking up a color image.

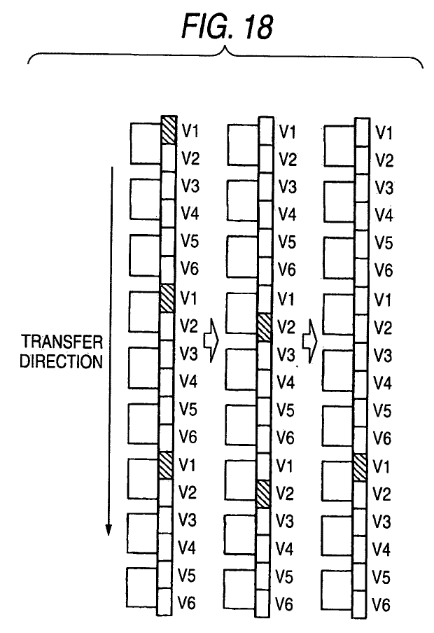

FIG. 18 is a drawing to show the state transition when the drive method of the first embodiment described above is applied. In this case, dark current of A11+A21+A31+A42 is mixed into the signal charge r1, dark current of A21+A32+A41 is mixed into a signal charge g1, dark current of A21+A32+A41 is mixed into the signal charge r2, and dark current of A41 is mixed into a signal charge g2 (not shown).

Seeing the signal charges r1 and r2 of the same red, A31+A42 is common as dark current mixed thereinto. Seeing the signal charges g1 and g2 of green, A41 is common as dark current mixed thereinto. That is, as for the red signal charges, if the dark current amount of A31 is large, red vertical line noise is conspicuous.

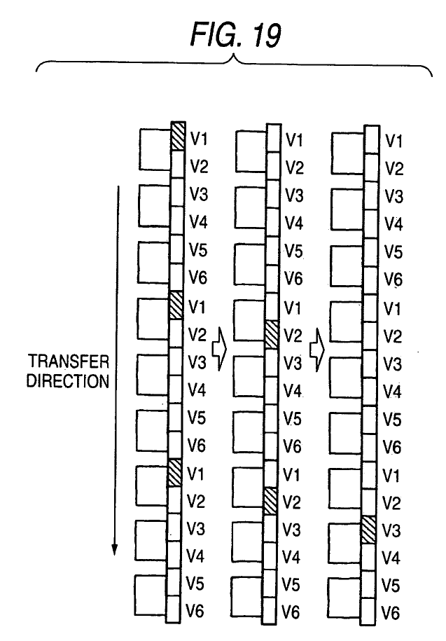

Then, if an odd number of electrodes are alternated as electrode V1→V2→V3→V1→V2→V3→ . . . as shown in a state transition diagram of FIG. 19, vertical line noise can be suppressed.

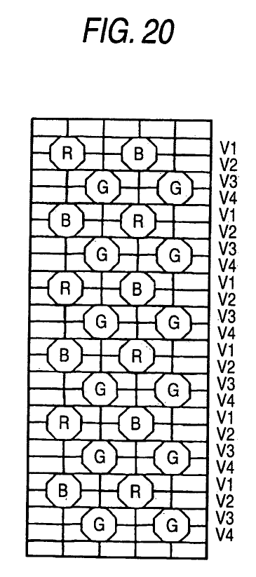

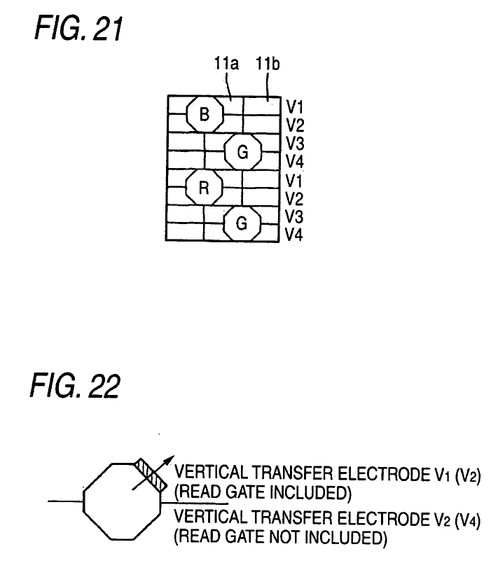

FIG. 20 is a surface schematic drawing of a CCD-type solid-state image pickup device for four-phase drive color image pickup of honeycomb pixel arrangement. FIG. 21 is an enlarged view of a part of FIG. 20 and FIG. 22 is an enlarged view of one pixel. For the honeycomb pixel arrangement, vertical charge transfer paths 11a and 11b shown in FIG. 21 differ in structure. Read-transfer electrode V1 of B pixel, R pixel shown in the figure is not read-transfer electrode in G pixel, and read-transfer electrode V3 of G pixel is not read-transfer electrode in R pixel.

Generally, dark current occurs much in a read electrode and thus if the electrode V3 which is not a read electrode in the vertical charge transfer path 11a is used as an electrode to form a potential well for retaining signal charge during stopping, the electrode V3 becomes a read electrode in the vertical charge transfer path 11b and dark current much occurs.

Therefore, if electrodes V2 and V4 which do not become read-transfer electrode in the vertical charge transfer path 11a, 11b are used as electrodes to form a potential well for retaining signal charge during stopping and are switched alternately, vertical line noise becomes inconspicuous.

As described above, according to the embodiment of the invention, the transfer electrode to form a potential well for retaining signal charge during stopping of the vertical charge transfer path among the transfer electrodes along the vertical charge transfer path is changed for each stop, so that occurrence of fixed pattern noise can be suppressed and vertical line noise can be made inconspicuous.

For the CCD-type solid-state image pickup device for picking up a color image, the transfer electrode to form a potential well for retaining signal charges of the same color during stopping of the vertical charge transfer path among the transfer electrodes along the vertical charge transfer path is changed for each stop, so that vertical line noise for each color can be made inconspicuous.

In the embodiments in FIGS. 6 and 10, the example of completely stopping the vertical charge transfer path during the transfer operation of the horizontal charge transfer path (not changing the vertical transfer pulse) has been described, but the stop condition of the vertical charge transfer path is not limited in the invention and a part of the vertical transfer pulses may change during the horizontal transfer and if the vertical charge transfer path is stopped repeatedly, the invention can be applied.

According to the invention, whenever the vertical charge transfer path is stopped, the transfer electrode position to form the potential well for retaining the signal charge on the vertical charge transfer path is changed, so that fixed pattern (vertical line) noise caused by dark current occurring because of fixing the transfer electrode can be made inconspicuous and the quality of a picked-up image can be enhanced Particularly, it is made possible to effectively suppress vertical line noise at the high speed photographing time with a small signal charge amount.

The drive method of the CCD-type solid-state image pickup device according to the invention can make vertical line noise caused by dark current inconspicuous and thus is useful if it is applied to an image pickup apparatus such as a digital camera including the high speed photographing mode.

The entire disclosure of each and every foreign patent application from which the benefit of foreign priority has been claimed in the present application is incorporated herein by reference, as if fully set forth.

What is claimed is:

1. A drive method of a CCD-type solid-state image pickup device, the image pickup device comprising vertical charge transfer path with vertical transfer electrodes, wherein the method transfers signal charges read from pixels of the image pickup device along the vertical charge transfer path,
the method comprising
a plurality of steps each of where transferring the signal charges along the vertical charge transfer path is stopped and the signal charges are retained in potential well(s) formed under given one(s) of the vertical transfer electrodes during the stopping of the transferring,
wherein said plurality of steps comprises a given step in which the given one(s) of the vertical transfer electrodes are changed from those of the vertical transfer electrodes in another one of said plurality of steps.

2. The drive method of the CCD-type solid-state image pickup device as claimed in claim 1,
wherein, in every steps of said plurality of steps, the given one(s) of the vertical transfer electrodes are changed from those in the previous step of the given step.

3. The drive method of the CCD-type solid-state image pickup device as claimed in claim 1,
wherein said plurality of steps conduct reading the signal charges of the pixels in a plurality of fields,
the given one(s) of the vertical transfer electrodes on reading those of the signal charges in one of the fields are changed from those of the vertical transfer electrodes on reading those of the signal charges in another one of the fields.

4. The drive method of the CCD-type solid-state image pickup device as claimed in claim 3,
wherein said plurality of steps are conducted for reading those of the signal charges in the same field, and
in every steps of said plurality of steps, the given one(s) of the vertical transfer electrodes are changed from those in the previous step of the given step.

5. The drive method of the CCD-type solid-state image pickup device as claimed in claim 1,
wherein the given one(s) of the vertical transfer electrodes are plural electrodes, and
a part of the plural electrodes is changed in the given step.

6. The drive method of the CCD-type solid-state image pickup device as claimed in claim 2,
wherein the given one(s) of the vertical transfer electrodes are changed cyclically over said plurality of steps.

7. The drive method of the CCD-type solid-state image pickup device as claimed in claim 2,
wherein the image pickup device further comprises color filters for the respective pixels so as to pick up a color image, and
the given one(s) of the vertical transfer electrodes are transfer electrodes, provided along the vertical charge transfer path, that form potential wells for retaining those of the signal charges of the same color.

8. The drive method of the CCD-type solid-state image pickup device as claimed in claim 1,
wherein the given one(s) of the vertical transfer electrodes are vertical transfer electrode (s) other than a vertical transfer electrode that also acts as a read electrode.

9. An image pickup apparatus comprising:
a CCD-type solid-state image pickup device; and
a CCD drive section that executes a drive method as claimed in claim 1.
